(19) United States
(12) Patent Application Publication
(10) Pub. No.: US 2015/0201602 A1
(43) Pub. Date: Jul. 23, 2015

(54) PORTABLE POWER BAIT STOARAGE AND DISPENSING APPARATUS

(71) Applicant: Matthew Hannah, Troutdale, OR (US)

(72) Inventor: Matthew Hannah, Troutdale, OR (US)

(21) Appl. No.: 14/161,631

(22) Filed: Jan. 22, 2014

(51) Int. Cl. A01K 97/04; A01K 85/00

(52) U.S. Cl. CPC A01K 97/04; A01K 85/00

(57) ABSTRACT

A power bait pen for allowing power bait strips to be stored, transported, and cutting comprises an elongated, hollow pen base and an accompanying pen cap. The pen base includes a spring loaded platform which holds strips of power bait strip and pushes them up towards the pen cap. the pen cap includes a hollow body portion and a hollow cutting compartment movably hinged thereto. A locking mechanism is included on the exterior of said cutting component and a cutting disc is disposed in the pen cap. When in operation, a chunk of power bait can be created from a strip of power bait which is disposed in the power bait pen simply by moving the locking mechanism to an unlocked position and engaging the cutting disc to cut the strip of power bait being fed from the spring loaded platform of the pen base.

### BACKGROUND OF THE INVENTION

1. Field of the Invention

This invention relates generally to fishing accessories and, more particularly, to a portable cutting device configured to cut material contained inside with an internal cutting apparatus.

2. Description of the Prior Art

Fishing is a well known practice which has been shown to have been a part of human lifestyles for tens of thousands of years. One of the most popular fishing techniques is angling, which is a method typically defined by the use of an angle, also known as a fish hook, connected to a fishing line that is connected to a fishing rod. When angling, the hook is often dressed with bait, which is intended to attract fish to the hook. Such bait can take the form of either natural or artificial, and the choice between various forms of bait is sometimes dictated by the target species or habitat.

A problem which still exists, however, is that for some forms of artificial bait, namely power bait, are difficult to transport and/or store when fishing due to the large, bulky design of housing containers and difficulties presented when users attempt to remove the bait itself from the housing container. Thus, there remains a need for a bait storage and dispensing apparatus which would allow for convenient transport and dispensing of power bait strips. It would be helpful if such a bait storage and dispensing apparatus eliminated the need for a user to have to manually handle the power bait to prepare it to be placed on a hook. It would be additionally desirable for such a bait storage and dispensing apparatus to be sized to maximize the ability of a user to transport power bait.

The Applicant's invention described herein provides for a power bait pen configured as a power bait storage and dispensing apparatus. The primary components of Applicant's power bait pen are a spring loaded pen base and a pen cap having an integrated cutting disc. When in operation, the power bait pen allows a user to store strips of power bait and, when desired, remove selectably sized chunks of power bait from the strip. As a result, many of the limitations imposed by the prior art storage containers are removed.

### SUMMARY OF THE INVENTION

A power bait pen for allowing power bait strips to be stored, transported, and cutting comprises an elongated, hollow pen base and an accompanying pen cap. The pen base includes a spring loaded platform which holds strips of power bait strip and pushes them up towards the pen cap. the pen cap includes a hollow body portion and a hollow cutting compartment movably hinged thereto. A locking mechanism is included on the exterior of said cutting component and a cutting disc is disposed in the pen cap between the body portion and the cutting compartment.

When in operation, a chunk of power bait can be created from a strip of power bait which is disposed in the power bait pen simply by moving the locking mechanism to an unlocked position and engaging the cutting disc to cut the strip of power bait being fed from the spring loaded platform of the pen base. The cutting compartment can then be opened and the chunk removed as desired by the user. Once the cutting compartment is closed and the locking mechanism placed in a closed position, the power bait pen securely stores the power bait strip until it is needed again, and allows for it to be transported in a convenient manner.

It is an object of this invention to provide a bait storage and dispensing apparatus which would allow for convenient transport and dispensing of power bait strips.

It is another object of this invention to provide a bait storage and dispensing apparatus which eliminates the need for a user to have to manually handle the power bait to prepare it to be placed on a hook.

It is yet another object of this invention to provide a bait storage and dispensing apparatus sized to maximize the ability of a user to transport power bait.

These and other objects will be apparent to one of skill in the art.

### BRIEF DESCRIPTION OF THE DRAWINGS

FIG. 1 is a side elevational view of a power bait pen built in accordance with the present invention.

FIG. 2 is a cross sectional, side elevational view of the pen base of a power bait pen built in accordance with the present invention.

FIG. 3 is a side elevational view of the pen cap of a power bait pen built in accordance with the present invention in its closed position.

FIG. 4 is a side elevational view of the pen cap of a power bait pen built in accordance with the present invention in its open position.

FIG. 5 is a top plan view of the pen cap of a power bait pen built in accordance with the present invention with its cutting blade in a set position.

FIG. 6 is a top plan view of the pen cap of a power bait pen built in accordance with the present invention with its cutting blade in a cutting position.

### DETAILED DESCRIPTION OF THE INVENTION

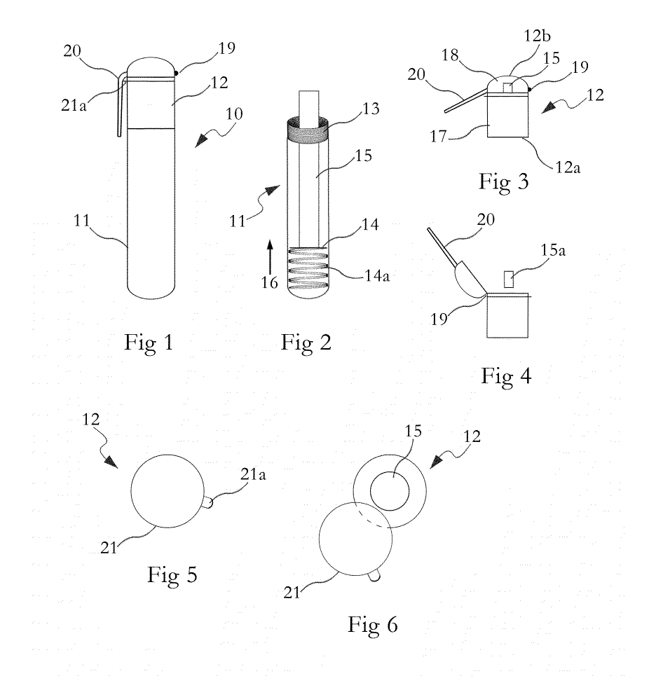

Referring now to the drawings and in particular FIGS. 1, 2 and 3, a power bait pen 10 is shown having a pen base 11 and a pen cap 12. In one embodiment, the power bait pen 10 measures six inches in length and has a dime sized diameter. The pen base 11 is an elongated, hollow body, with a threaded portion 13 which is adapted to engage the proximal end 12a of the pen cap 12. The pen base 11 additionally includes a spring loaded platform 14 and a spring 14a disposed in its hollow body which is adapted to hold a power bait strip 15 while maintaining pressure on said power bait strip 15 in an upward direction 16 at all times.

Referring now to FIGS. 1, 3 and 4, the pen cap 12 includes a hollow body portion 17 and a hollow cutting compartment 18 movably hinged thereto. The hollow body portion 17 internal body includes threads (not shown) to allow the proximal end 12a of the pen cap 12 to screw on and attach to the pen base 11. A hinge component 19 is disposed on the pen cap 12 to allow the cutting compartment to be hinged open at the distal end 12b of said pen cap 12. A locking mechanism 20 is included on the exterior of said cutting component 18. FIG. 1 shows the locking mechanism 20 is its locked position, wherein the cutting compartment 18 is kept in a fixed, closed position as also shown in FIG. 1. FIGS. 3 and 4 show the locking mechanism 20 is its unlocked position, wherein the cutting compartment 18 can be hinged into an open position as also shown in FIG. 4. In one embodiment, the locking mechanism 20 employs a latch bolt system which is engaged and disengaged when the locking mechanism 20 is moved to its locked and unlocked positions, respectively. It is understood, however, that other fastening mechanisms may be used.

Referring now to FIGS. 1, 3, 4, 5 and 6, a cutting disc 21 is disposed in the pen cap 12 between the body portion 17 and the cutting compartment 18. The cutting disc 21 is attached to a cutting handle 21a disposed on its exterior surface in a manner which enables the cutting disc 21 to be manually moved from a set position, as shown in FIG. 5 to the cutting position shown in FIG. 6. The body portion 17 includes a cutting slot 17a to provide a channel for the cutting disc 18 to move between said set position and cutting position. The pen cap 12 is additionally configured such that when the cutting disc 18 is in the set position and the cutting compartment 18 is hinged closed, the cutting handle 21 is held in a fixed place by the locking mechanism 20. In this regard, only when the locking mechanism 20 is moved into the unlocked position can the cutting disc 21 be moved.

It is appreciated that when the cutting disc 21 is moved from the cutting position to the set position, a power bait strip 15 which is extended from the pen base 11 through the body portion 17 and up to the cutting compartment 18 will be cut by the cutting disc 21. At this point, the cutting compartment 18 can be opened and a power bait chunk 15a can be removed.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A power bait strip storage and dispensing apparatus, comprising:
a pen base defined by an elongated hollow base body with an enclosed bottom end and an open top end, wherein said pen base is sized to slidably fit a strip of power bait; and
a pen cap having a cutting disc and adapted to removably attach to said top end of the pen base, enabling any power bait strip disposed in the hollow base body of said pen base to be passed into the pen cap, wherein said cutting disc is configured to cut power bait strip which has been passed into the pen cap.

2. The power bait strip storage and dispensing apparatus of claim 1, wherein said pen base includes a spring loaded platform in its hollow base body.

3. The power bait strip storage and dispensing apparatus of claim 1, wherein the pen cap is defined by a hollow cap body and a cutting compartment movably attached to said cap body.

4. The power bait strip storage and dispensing apparatus of claim 3, wherein said cutting compartment is hinged to said hollow cap body, enabling the cutting compartment to move between an open position and a closed position.

5. The power bait strip storage and dispensing apparatus of claim 3, additionally comprising a locking mechanism disposed on said pen cap which is adapted to enable the cutting compartment to be selectively locked in the closed position.

6. The power bait strip storage and dispensing apparatus of claim 6, wherein the locking mechanism is additionally adapted to restrict the movement of the cutting disc.

7. The power bait strip storage and dispensing apparatus of claim 3, wherein the cutting disc is oriented on said cap body and positioned to be slid through a cutting slot on said cap body.

8. A method of dispensing chunks from a strip of power bait, comprising the steps of:
providing a pen base defined by an elongated hollow base body with an enclosed bottom end and an open top end, wherein said pen base is sized to slidably fit a strip of power bait;
providing a pen cap having a cutting disc removably attached to said top end of the pen base, enabling any power bait strip disposed in the hollow base body of said pen base to be passed into the pen cap, wherein said cutting disc is configured to cut power bait strip which has been passed into the pen cap;
causing a strip of power bait to be placed in said pen base and moved into said pen cap; and
engaging said cutting disc, enabling it to move through the strip of power bait.

9. The method of claim 8, wherein said pen base includes a spring loaded platform in its hollow base body which moves the strip of power bait to into said pen cap.

10. The method of claim 8, wherein the pen cap is defined by a hollow cap body and a cutting compartment movably attached to said cap body.

11. The method of claim 10, wherein said cutting compartment is hinged to said hollow cap body, enabling the cutting compartment to move between an open position and a closed position.

12. The method of claim 10, wherein said pen cap includes a locking mechanism which is adapted to enable the cutting compartment to be selectively locked in the closed position.

13. The method of claim 12, wherein the locking mechanism is additionally adapted to restrict the movement of the cutting disc.

14. The method of claim 10, wherein the cutting disc is oriented on said cap body and positioned to be slid through a cutting slot on said cap body.
